(19) United States
(12) Patent Application Publication
(10) Pub. No.: US 2026/0321485 A1
(43) Pub. Date: Oct. 15, 2026

(54) TRANSFORMER AND POWER SUPPLY UNIT USING SAME

(71) Applicant: LG INNOTEK CO., LTD., Seoul (KR)

(72) Inventors: Yong Ha CHOI, Seoul (KR); Bi Yi KIM, Seoul (KR); Sue Kyung OH, Seoul (KR)

(21) Appl. No.: 19/119,033

(22) PCT Filed: Oct. 6, 2023
(86) PCT No.: PCT/KR2023/015404

§ 371 Date: Apr. 7, 2025

(30) Foreign Application Priority Data
Oct. 7, 2022 (KR) 10-2022-0128358
Oct. 7, 2022 (KR) 10-2022-0128359

(51) Int. Cl. H01F 27/32; H01F 27/24

(52) U.S. Cl. CPC H01F 27/325; H01F 27/24

(57) ABSTRACT

The present invention relates to a transformer capable of maximizing a coil separation effect by reducing parasitic capacitance and a power supply unit including same. The transformer comprises: a bobbin in which a plurality of winding spaces are formed in the outer surface of the tubular body having a through hole formed at the inner center; and a plurality of coils stacked and wound in the plurality of winding spaces. The bobbin is provided with at least one section that protrudes parallel to an upper flange and a lower flange in the outer diameter direction from the body portion and separates the winding space into a plurality of winding spaces. The winding space is separated by using the section, and coil wires are spaced apart from each other, and thus the parasitic capacitance can be effectively lowered. Also, the contact area at a wiring connecting portion can be reduced by spacing the wires apart from each other by using the section, and thus insulation stability can be increased.

### TECHNICAL FIELD

The present disclosure relates to a transformer and a power supply unit, and more particularly, to a transformer capable of maximizing a coil separation effect by reducing parasitic capacitance and a power supply unit including the same.

### BACKGROUND ART

In general, driving power is required in order to drive an electronic device, and a power supply unit (PSU) is essentially employed in order to supply driving power to the electronic device.

In particular, a display device, such as a flat panel TV, is required to be slim, and is continually being embodied in increasingly larger sizes. Accordingly, it is necessary to reduce the thickness of such a large-scale display while meeting the increased power requirements thereof.

In the power supply unit, a transformer occupies a relatively large volume compared to other elements. In order to realize a slim transformer, a method of omitting thick elements from the transformer or adjusting the number thereof is generally considered.

As a transformer is slimmed, an interval between wound coils is reduced. This increases parasitic capacitance between the coils. Increase in parasitic capacitance causes increase in operating frequency during no-load operation.

In a power supply unit, increase in parasitic capacitance may cause variation in output voltage under no-load conditions.

### DISCLOSURE

### Technical Problem

An object of the present disclosure is to provide a transformer capable of reducing parasitic capacitance and a power supply unit using the same.

Another object of the present disclosure is to provide a transformer capable of effectively separating windings and a power supply unit using the same.

### Technical Solution

A transformer according to an embodiment of the present disclosure for accomplishing the above objects may include a bobbin including a plurality of winding spaces defined on the outer peripheral surface of a tubular body part having a through-hole formed in the center thereof and a plurality of coils wound in the plurality of winding spaces in a stacked manner, wherein the bobbin may include at least one section protruding from the body part in parallel to an upper flange and a lower flange to divide the winding space into a plurality of winding spaces.

In the transformer according to an embodiment of the present disclosure, the plurality of winding spaces may have the same size.

In the transformer according to an embodiment of the present disclosure, the section may divide the winding space into a lower winding space and an upper winding space.

In the transformer according to an embodiment of the present disclosure, the section may include a plurality of sections dividing the winding space into three or more winding spaces having the same width.

In the transformer according to an embodiment of the present disclosure, the through-hole may have a rectangular cross-section.

In the transformer according to an embodiment of the present disclosure, the upper flange and the lower flange may have widths equal to or less than the width between inner peripheral surfaces of the through-hole closely facing each other.

In the transformer according to an embodiment of the present disclosure, the upper flange and the lower flange may have widths greater than the width between inner peripheral surfaces of the through-hole closely facing each other.

In the transformer according to an embodiment of the present disclosure, the plurality of coils may include a primary coil and a secondary coil, and at least one of the primary coil and the secondary coil may be a multi-insulated coil.

In the transformer according to an embodiment of the present disclosure, a part of the plurality of coils may be wound so as to surround the outer peripheral surface of the section.

In the transformer according to an embodiment of the present disclosure, the section may have a thickness equal to the thicknesses of the upper flange and the lower flange.

In the transformer according to an embodiment of the present disclosure, the thickness of the section may be 0.4 to 0.7 times the thicknesses of the upper flange and the lower flange.

In the transformer according to an embodiment of the present disclosure, the section may have a width formed to be 0.2 to 0.4 times the widths of the upper flange and the lower flange.

In the transformer according to an embodiment of the present disclosure, the section may have a width formed to be 0.6 to 0.8 times the widths of the upper flange and the lower flange.

In the transformer according to an embodiment of the present disclosure, the section may have the same width as the upper flange and the lower flange.

In the transformer according to an embodiment of the present disclosure, the coil may have a winding width less than the width of the section.

A transformer according to another embodiment of the present disclosure may include a core unit including an upper core and a lower core, a bobbin including a through-hole formed in the center thereof so as to accommodate at least a part of the core unit, and a coil unit at least partially accommodated in the core unit, the coil unit being disposed on the outer peripheral surface of the through-hole, the coil unit including a primary coil and a secondary coil, wherein the bobbin may include an upper flange protruding from an end of the outer peripheral surface of the through-hole in a first direction and a second direction perpendicular to the first direction, a lower flange protruding from the opposite end of the outer peripheral surface of the through-hole in the first direction and the second direction, a first section disposed between the upper flange and the lower flange, the first section protruding from the outer peripheral surface in the first direction, and a second section protruding from the outer peripheral surface in the second direction on the same line as the first section by a width equal to or less than the width of the first section.

In the transformer according to the other embodiment of the present disclosure, the ratio of the width of the second section protruding from the outer peripheral surface to the width of the first section protruding from the outer peripheral surface may be 0.1:1 to 1:1

A power supply unit according to the present disclosure may include a transformer including a bobbin including a plurality of winding spaces defined on the outer peripheral surface of a tubular body part having a through-hole formed in the center thereof and a plurality of coils wound in the plurality of winding spaces in a stacked manner, wherein the bobbin may include at least one section protruding from the body part in parallel to an upper flange and a lower flange to divide the winding space into a plurality of winding spaces, and a board configured to allow the transformer to be mounted thereon.

### Advantageous Effects

The transformer and the power supply unit using the same according to the present disclosure may increase a separation effect between windings despite slimness thereof, thereby preventing increase in parasitic capacitance between the windings.

### DESCRIPTION OF DRAWINGS

FIG. 1 is a perspective view of a transformer according to a first embodiment of the present disclosure.

FIG. 2 is view of an embodiment of the bobbin in FIG. 1.

FIG. 3A is a cross-sectional view of a general transformer.

FIGS. 3B to 3D are cross-sectional views taken along line A-A′ in FIG. 1.

FIG. 4 is a graph showing reduction in parasitic transformer according to the present disclosure.

FIGS. 5A to 5C are front views of FIGS. 3B to 3D.

FIG. 6 is a perspective view of a transformer according to a second embodiment of the present disclosure.

FIG. 7 is a view of an embodiment of the bobbin in FIG. 6.

FIGS. 8A to 8C are cross-sectional views taken along line B-B′ in FIG. 6.

FIG. 9 is a perspective view of a transformer according to a third embodiment of the present disclosure.

FIG. 10 is a view of an embodiment of the bobbin in FIG. 9.

FIG. 11 is a perspective view of a transformer according to a fourth embodiment of the present disclosure.

FIG. 12 is a view of an embodiment of the bobbin in FIG. 11.

FIG. 13 is a view illustrating a power supply unit on which the transformer according to the present disclosure is mounted.

### BEST MODE

Various exemplary embodiments will now be described more fully with reference to the accompanying drawings, in which only some exemplary embodiments are shown. Specific structural and functional details disclosed herein are merely representative for the purpose of describing exemplary embodiments. The present disclosure, however, may be embodied in many alternative forms, and should not be construed as being limited to the exemplary embodiments set forth herein.

Accordingly, while exemplary embodiments of the disclosure are capable of being variously modified and taking alternative forms, embodiments thereof are shown by way of example in the drawings and will herein be described in detail. It should be understood, however, that there is no intent to limit the present disclosure to the particular exemplary embodiments disclosed. On the contrary, exemplary embodiments are to cover all modifications, equivalents, and alternatives falling within the scope of the disclosure.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present disclosure.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements should be interpreted in a like fashion (e.g. “between” versus “directly between”, “adjacent” versus “directly adjacent”, etc.).

The terminology used herein is for the purpose of describing particular embodiments only and is not intended to be limiting of exemplary embodiments of the disclosure. As used herein, the singular forms are intended to include the plural forms as well, unless the context clearly indicates otherwise. It will be further understood that the term “include” or “have”, when used herein, specifies the presence of stated features, integers, steps, operations, elements, components, or combinations thereof, but do not preclude the presence or addition of one or more other features, integers, steps, operations, elements, components, or combinations thereof.

Unless otherwise defined, all terms used herein, which include technical or scientific terms, have the same meanings as those generally appreciated by those skilled in the art. The terms, such as ones defined in common dictionaries, should be interpreted as having the same meanings as terms in the context of pertinent technology, and should not be interpreted as having ideal or excessively formal meanings unless clearly defined in the specification.

Meanwhile, when a certain embodiment is capable of being realized in a different manner, functions or operations specified in a specific block may be executed in an order different from that shown in a flowchart. For example, two consecutive blocks may be executed simultaneously, or may be executed in the reverse order, depending on the related function or operation.

Hereinafter, a transformer and a power supply unit using the same according to the present disclosure will be described with reference to the accompanying drawings.

In addition, considering that a transformer related to the embodiments is mounted on a circuit board of a display device, the thickness (or the vertical height) of the transformer according to the present disclosure for contributing to slimness of the display device may be 14 mm or less, desirably 12 mm or less, and more desirably 10 mm or less, from the upper surface of the circuit board.

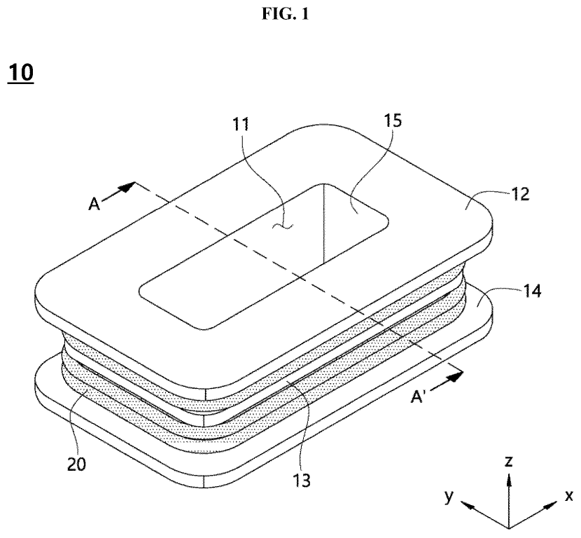

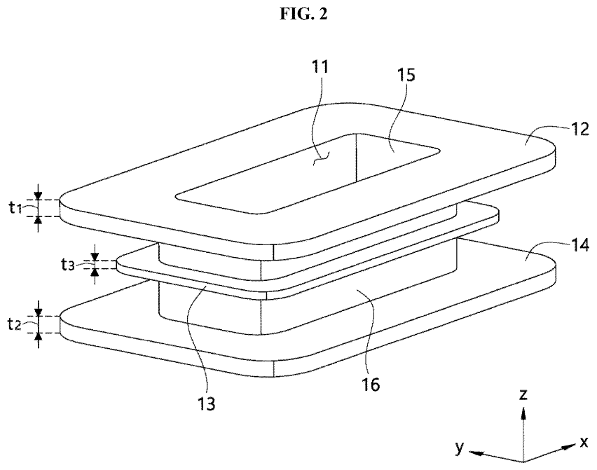

FIG. 1 is a perspective view of a transformer according to an embodiment of the present disclosure, and FIG. 2 is view of an embodiment of a first bobbin with the coil in FIG. 1 removed therefrom. As shown in the drawings, a bobbin 10 of the transformer includes two winding spaces divided by a section 13, and a coil 20 is wound in the winding spaces in a stacked manner.

The bobbin 10 includes a through-hole 11 formed in the center thereof, upper and lower flanges 12 and 14 extending from an outer peripheral surface 16 of a body part 15, which is formed in a tubular shape, in a first direction, which is the outer diameter direction, to define a winding space, and a section 13 protruding in the first direction between the upper flange 12 and the lower flange 14 to divide the winding space into a plurality of winding spaces. In this case, the section 13 may protrude from the outer peripheral surface 16 in parallel to the upper flange 12 and the lower flange 14.

The coil 20 may be wound in the plurality of spaces divided by the section 13, i.e., an upper winding space S1 and a lower winding space S2. The coil 20 disposed in the bobbin 10 may be any one of a primary coil and a secondary coil, and in this case, a second bobbin (not shown) in which the other of the primary coil and the secondary coil is disposed may be provided outside the bobbin 10 in the first direction. That is, the primary coil and the secondary coil may at least partially overlap each other in the first direction. Such overlap between the primary coil and the secondary coil in the first direction may not only contribute to slimness of the transformer, but also enable additional securement of a leakage inductance value required for a display. The second bobbin may include a section formed in a manner similar to that of the bobbin 10.

The upper flange 12 and the lower flange 14 serve to support the coil 20 wound in the winding spaces on both sides, and because the upper flange 12 and the lower flange 14 are formed of an insulative material, the same also serve to ensure insulation between the outside and the coil 20.

In the embodiment, the thickness t1 of the upper flange 12 and the thickness t2 of the lower flange 14 are the same (t1=t2). However, the thicknesses t1 and t2 may be different (t1≠t2). The thickness t3 of the section 13 may be equal to or less than the thicknesses t1 and t2 of the upper flange 12 and the lower flange 14 (t1>t3 or t2>t3). The thickness of the section 13 may be 0.4 mm to 1.0 mm. With regard to the minimum thickness of 0.4 mm, it is necessary to design and manufacture the section to a thickness of 0.4 mm or greater in consideration of the resolution of the bobbin injection-molding process and stress caused by tension in the winding process. On the other hand, with regard to the maximum thickness of 1.0 mm, the effective window area of the transformer, which is available to wind the coil, and the cross-sectional area of the coil are reduced as the thickness of the section increases in a given space. Thus, if the section is manufactured to a thickness greater than necessary, the amount of heat generated from the transformer increases, which may increase the possibility of the coil being damaged, resulting in deterioration in the performance of the transformer.

The thickness t3 of the section 13 may be 0.4 to 0.7 times the thickness t1 or t2 of each of the flanges 12 and 14. The thicknesses of the flanges 12 and 14 and the section 13 may gradually decrease in the outer diameter direction.

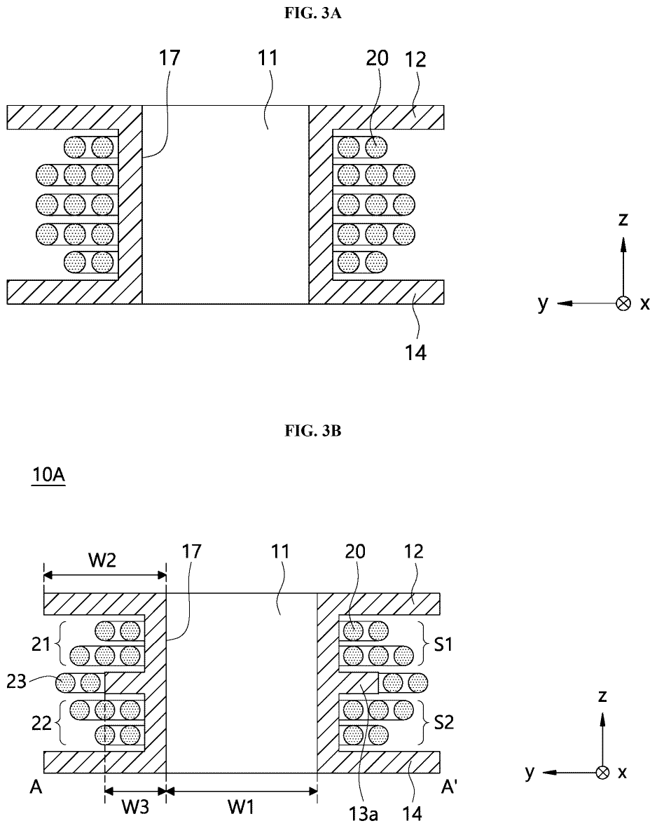

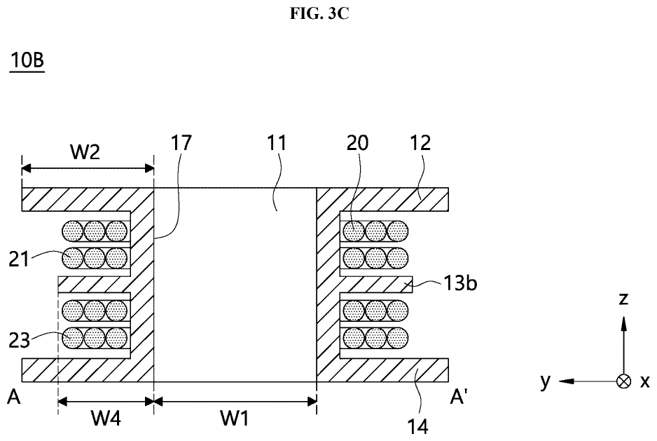

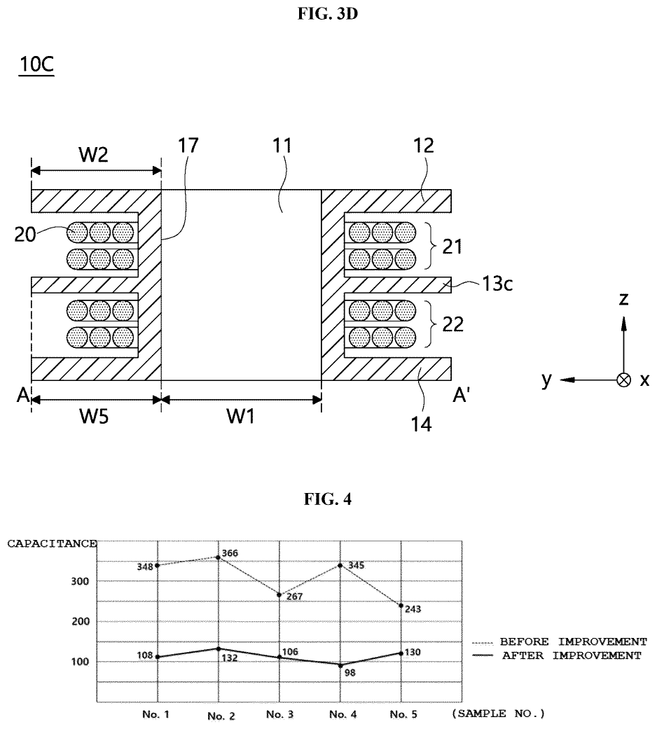

FIG. 3A is a cross-sectional view of a general transformer. As shown in the drawing, a through-hole 11 formed in a body of a bobbin is used as a passage into which a center leg (not shown), which is a part of a core, is inserted. The embodiment will be described based on an example in which the through-hole 11 has a rectangular cross-section. This is a configuration formed according to the shape of the core inserted into the through-hole 11. The bobbin 10 according to the present disclosure is not limited thereto, and may be formed to have various shapes of through-holes 11 according to the shape of the center leg inserted into the through-hole 11. When the coil 20 is wound along the outer peripheral surface of the through-hole 11, bending and non-uniform winding of the coil may result in increase in leakage inductance.

FIGS. 3B to 3D are cross-sectional views of the bobbin and the coil of the transformer according to the present disclosure taken along line A-A′ in FIG. 1. The width W2 of the upper flange 12 and the width W2 of the lower flange 14 may be equal to or less than the width W1 between two inner peripheral surfaces of the through-hole 11, which are relatively close to each other among two pairs of opposite inner peripheral surfaces 17 of the through-hole 11 (W1≥W2). The center leg of the core is inserted into the through-hole 11 corresponding to the width W1 between the two inner peripheral surfaces of the through-hole 11 that are relatively close to each other, and the space corresponding to the widths W2 of the upper flange 12 and the lower flange 14 is related to an effective window area in which the coil is wound, and may be designed according to the use environment.

Here, the width W2 of the flange is a horizontal distance from one of the two inner peripheral surfaces of the through-hole 11 that are relatively close to each other among the inner peripheral surfaces of the through-hole 11 in the body part 15 to the outer peripheral surface of each of the flanges 12 and 14.

The space defined by the upper flange 12, the outer peripheral surface 16 of the body part 15, and the section 13 corresponds to the first winding space (upper winding space S1) in which a part of the coil 20 is wound. The space defined by the section 13, the outer peripheral surface 16 of the body part 15, and the lower flange 14 corresponds to the second winding space (lower winding space S2) in which a part of the coil 20 is wound. The coil 20 may be wound around the outer peripheral surface 16 of the body part 15 in various orders and forms. That is, any one of the primary coil and the secondary coil may first be wound in the first winding space S1, and may then be wound in the second winding space S2. If necessary, the coil may first be wound in the second winding space S2, and may then be wound in the first winding space S1.

The section 13 may be formed to various thicknesses and may be formed of various materials, so long as the same is maintained in a shape capable of contributing to reduction in parasitic capacitance through separation between windings. Further, although the embodiment is described based on an example in which the section 14 is integrally formed with the body part 15 of the bobbin 10, the present disclosure is not limited thereto, and various applications, for example, a configuration in which the section 14 is formed as a separate independent member and is coupled to the bobbin 10, are possible. The coil 20 may be protected and insulated from the outside.

As shown in FIGS. 3B to 3D, sections 13a, 13b, and 13c having various widths may be formed. In this case, the width of the section is a horizontal distance by which the section extends in the outer diameter direction from one of the two inner peripheral surfaces of the through-hole 11 that are relatively close to each other among the inner peripheral surfaces of the through-hole 11 in the body part 15.

In the embodiment in FIG. 3B, the coil 20 wound on the bobbin 10A may include a coil 21 wound in the upper winding space S1, a coil 22 wound in the lower winding space S2, and a coil 23 wound so as to surround the outer peripheral surface of the section 13a. In this case, the width of the coil 20 disposed in each of the upper winding space S1 and the lower winding space S2 is greater than the width of the section 13a, so that some windings are separated, but others are not separated. Thus, a parasitic capacitance reduction effect through separation between windings is insignificant.

Meanwhile, in the embodiment in FIG. 3C, the winding width of the coil wound in each of the winding spaces S1 and S2 in the bobbin 10B is less than the width W4 of the section 13b. When the width W4 of the section 13b is 0.3 to 0.9 times, desirably 0.4 to 0.7 times, the widths W2 of the upper flange 12 and the lower flange 14, the coil 21 wound in the upper winding space S1 and the coil 22 wound in the lower winding space S2 among the coils 20 wound on the bobbin 10A are reliably separated from each other. Thus, as indicated by the graph in FIG. 4, this configuration may aid in improvement in parasitic capacitance to an ordinary level (average reduction) and improvement of dispersion (reduction of standard deviation). In the graph, “BEFORE IMPROVEMENT” represents a configuration having no section, “AFTER IMPROVEMENT” represents a configuration having the section, and parasitic capacitances measured in five sample transformers are shown. It may be seen from the graph that the parasitic capacitance is reduced to an ordinary level after improvement.

The average improvement effect, i.e., reduction in the absolute value of the parasitic capacitance, may resolve malfunction of the module caused by increase in the parasitic capacitance of the parts of the transformer, for example, no-load voltage regulation errors. The dispersion improvement effect may mean improvement of price competitiveness of the parts of the transformer and improvement of the mass production yield of transformer manufacturers.

In addition, both ends of the coil 20, i.e., the start point and the end point of the coil 20, in each of the winding spaces S1 and S2 are disposed so as to be separated from each other, so that insulation stability may be further increased.

In the embodiment in FIG. 3D, the width W5 of the section 13c is formed to exceed 0.9 times the widths W2 of the upper flange 12 and the lower flange 14. In this case, the coil 21 wound in the upper winding space S1 and the coil 22 wound in the lower winding space S2 among the coils 20 wound on the bobbin 10A are more reliably separated from each other, and accordingly, the parasitic capacitance may be further reduced. However, because the volumes of the upper winding space S1 and the lower winding space S2 excessively increase due to increase in the width of the section, the respective winding spaces may retain heat generated from the core and the coil during operation of the transformer, leading to increase in the temperature of the transformer, and damage to the section, such as bending of the section, may occur in the process of winding the coil 20.

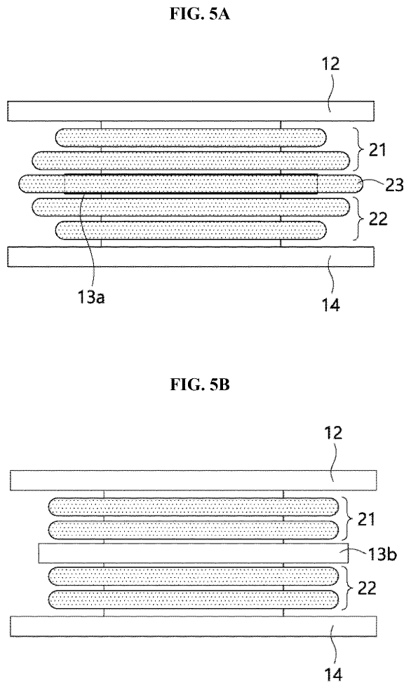

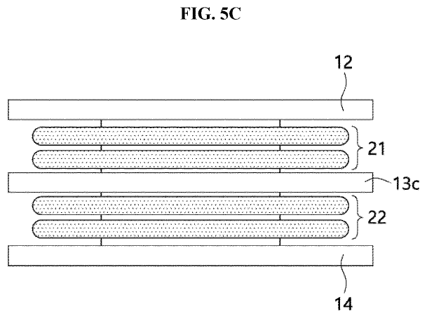

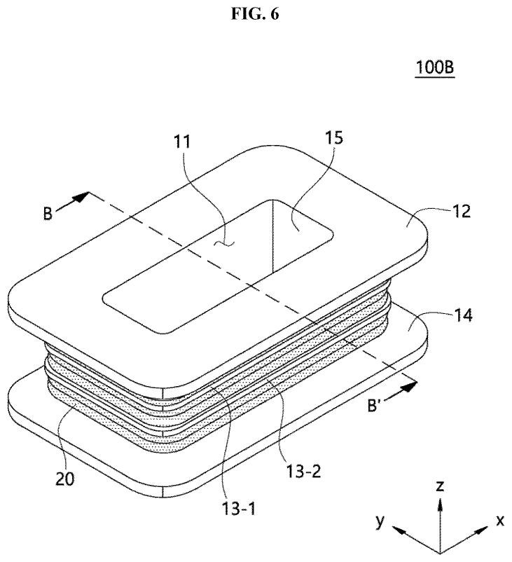

FIGS. 5A to 5C are front views of FIGS. 3B to 3D. As shown in FIG. 5A, the coil is first wound in the first winding space S1, is wound so as to surround the outer peripheral surface of the section 13a, and is then wound in the second winding space S2. As mentioned above, the coil may first be wound in the second winding space S2, may be wound so as to surround the outer peripheral surface of the section 13a, and may then be wound in the first winding space S1. Although not shown in detail, the primary coil may be wound on the outer peripheral surface of the bobbin, and the secondary coil may be wound outside the primary coil. In this case, at least one of the primary coil or the secondary coil may be a multi-insulated coil.

As shown in FIGS. 5B and 5C, the width W3 or W4 of the section 13a or 13b may be formed to be 0.4 to 0.7 times the widths W2 of the flanges 12 and 14, or the width W5 of the section 13c may be formed to exceed 0.9 times the widths W2 of the flanges 12 and 14.

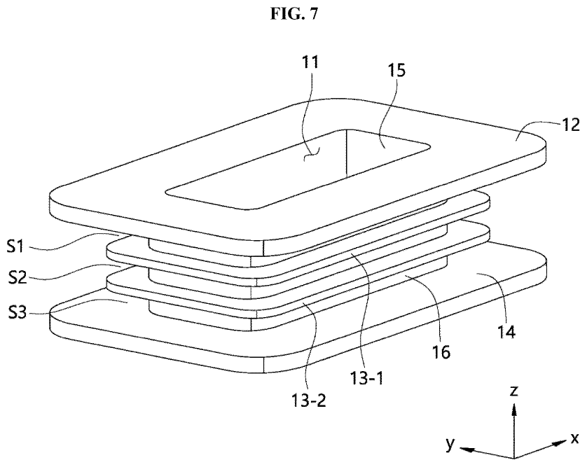

FIG. 6 is a perspective view of a bobbin and a coil of a transformer according to a second embodiment of the present disclosure, and FIG. 7 is a view of an embodiment of the bobbin in FIG. 6. When a part has a large height and thus has an extra space and the number of windings of the coil to be wound is large, as in the second embodiment, another section may be added to the body part of the bobbin in order to more effectively separate the windings. This is merely exemplary, and more sections may be added in order to further divide the winding space.

Unlike the embodiment in FIG. 1, a bobbin 100B of a transformer in which two sections 13-1 and 13-2 are formed is shown. Although the two sections 13-1 and 13-2 are illustrated as dividing the winding space into three winding spaces S1, S2, and S3 having the same size, this is merely a preferred embodiment, and the winding spaces S1, S2, and S3 may be formed to have different sizes depending on the positions at which the sections are formed on the outer peripheral surface 16 of the body part 15.

In addition, although the two sections 13-1 and 13-2 are illustrated as having the same thickness and the same width, this is merely a preferred embodiment, and the two sections may have different thicknesses or different widths as needed.

Description of the configurations identical to those of the first embodiment shown in FIGS. 1 and 2 will be omitted. The bobbin 100B of the transformer according to the second embodiment of the present disclosure includes a bobbin 10 having three winding spaces S1, S2, and S3 divided by the two sections 13-1 and 13-2 and a coil 20 wound in each winding space in a stacked manner.

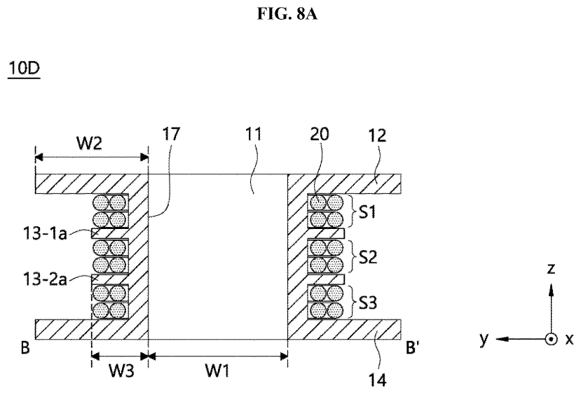

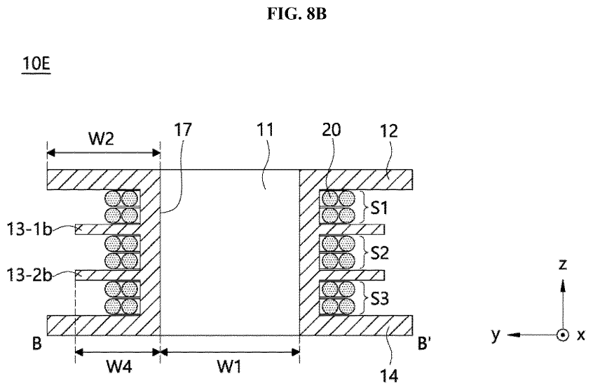

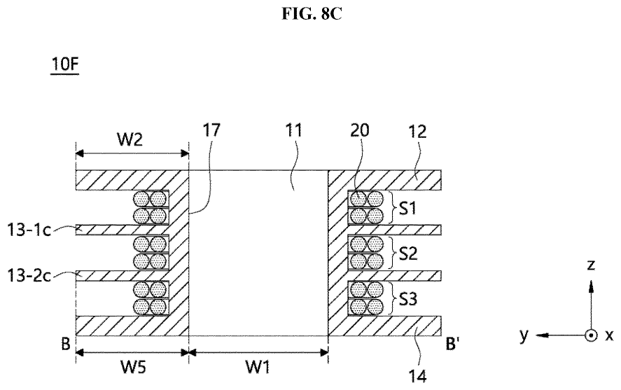

FIGS. 8A to 8C are cross-sectional views taken along line B-B′ in FIG. 6. As shown in FIG. 8A, the coils 20 are wound in the winding spaces S1, S2, and S3 while being separated by the sections 13-1a and 13-2a. In this case, the width of the coil 20 disposed in each of the winding spaces is greater than the widths of the sections 13-1a and 13-2a, so that some windings are separated, but others are not separated. Thus, a parasitic capacitance reduction effect through separation between windings is insignificant.

Similar to the first embodiment, as shown in FIG. 8B, the transformer 100B according to the second embodiment may be configured such that the widths W4 of the sections 13-1b and 13-2 b formed on the bobbin 10E are 0.3 to 0.9 times, desirably 0.4 to 0.7 times, the widths W2 of the upper flange 12 and the lower flange 14. In this case, the coils 20 wound in the winding spaces S1, S2, and S3 in the bobbin 10B may be reliably separated from each other.

In addition, as shown in FIG. 8C, the widths W5 of the sections 13-1c and 13-2c formed on the bobbin 10F may be formed to exceed 0.9 times the widths W2 of the upper flange 12 and the lower flange 14. In this case, the coils 20 wound on the bobbin 10B are more reliably separated from each other, and accordingly, the parasitic capacitance may be further reduced. However, because the volumes of the winding spaces excessively increase due to increase in the width of the section, the respective winding spaces may retain heat generated from the core and the coil during operation of the transformer, leading to increase in the temperature of the transformer, and damage to the section, such as bending of the section, may occur in the process of winding the coils 20.

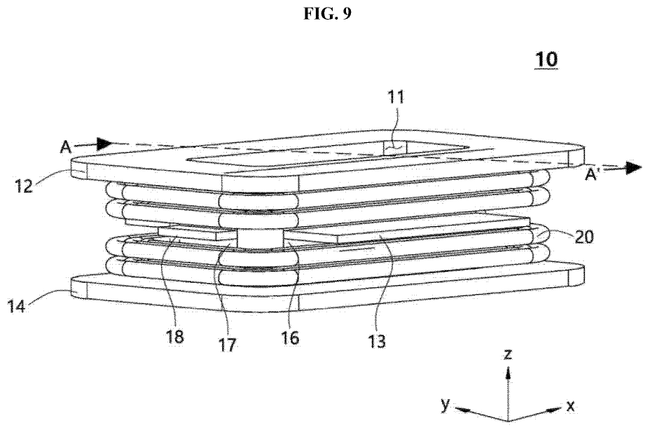

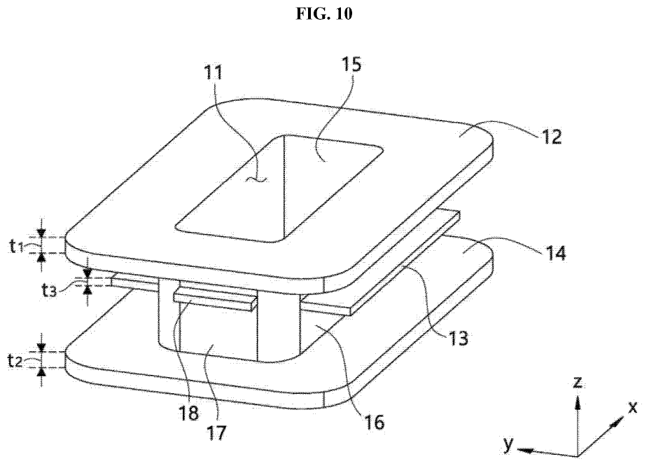

FIG. 9 is a perspective view of a transformer according to a third embodiment of the present disclosure, and FIG. 10 is a view of an embodiment of a bobbin with the coil in FIG. 9 removed therefrom.

As shown in the drawings, a bobbin 10 of a transformer includes two winding spaces divided by a first section 13 and a second section 18, and a coil 20 is wound in each of the winding spaces in a stacked manner.

The bobbin 10 includes a body part 15, an upper flange 12, a lower flange 14, a first section 13, and a second section 18. The body part 15 is formed in a tubular shape, and a through-hole 11 for accommodating a part of a core (not shown) is formed in the center of the body part 15.

The upper flange 12 and the lower flange 14 protrude from both ends of the body part 15 in the outer diameter direction of the outer peripheral surface 16 of the body part 15.

The first section 13 protrudes in a first direction (e.g., the x-axis) from the outer peripheral surface 16 between the upper flange 12 and the lower flange 14. The second section 18 protrudes in a second direction (e.g., the y-axis) from the outer peripheral surface 16 on the same line as the first section 13. In this case, the x-axis direction and the y-axis direction are directions perpendicular to each other on the same horizontal line, and the first section 13 and the second section 18 may protrude from the outer peripheral surface 16 in parallel to the upper flange 12 and the lower flange 14.

The ratio of the protruding width of the second section 18 from the outer peripheral surface 16 to the protruding width of the first section 13 from the outer peripheral surface 16 may be 0.1:1 to 1:1. That is, the second section 18 protrudes by a width equal to or less than that of the first section 13.

A termination end of the wound coil 20 should be wired in a portion of the bobbin 10 at which the second section 18 is formed in order to be connected to a terminal pin. In this case, if the second section 18 protrudes too long from the outer peripheral surface 16, a path along which the termination end of the coil 20 reaches the terminal pin becomes longer. Therefore, if the protruding width of the second section 18 is appropriately reduced according to the volume of the coil 20 to be wound, unnecessary increase in size may be prevented.

As the volume of the transformer increases, the sizes of the bobbin 10 and the sections 13 and 18 also increase in proportion thereto. If the second section 18 protrudes too long, the same becomes structurally unstable, so the second section 18 may be damaged during the coil wiring process. Therefore, if the protruding width of the second section is reduced, the mechanical stability thereof may be enhanced, so that damage thereto may be prevented. Reduction in the length of the second section 18 may contribute to reduction in the weight of the part.

The thicknesses of the first section 13 and the second section 18 may be 0.4 mm to 1.0 mm. With regard to the minimum thickness of 0.4 mm, it is necessary to design and manufacture the section to a thickness of 0.4 mm or greater in consideration of the resolution of the bobbin injection-molding process and stress caused by tension in the winding process. On the other hand, with regard to the maximum thickness of 1.0 mm, the effective window area of the transformer, which is available to wind the coil, and the cross-sectional area of the coil are reduced as the thickness of the section increases in a given space. Thus, if the section is manufactured to a thickness greater than necessary, the amount of heat generated from the transformer increases, which may increase the possibility of the coil being damaged, resulting in deterioration in the performance of the transformer.

The thicknesses t3 of the first section 13 and the second section 18 may be 0.4 to 0.7 times the thickness t1 or t2 of each of the flanges 12 and 14.

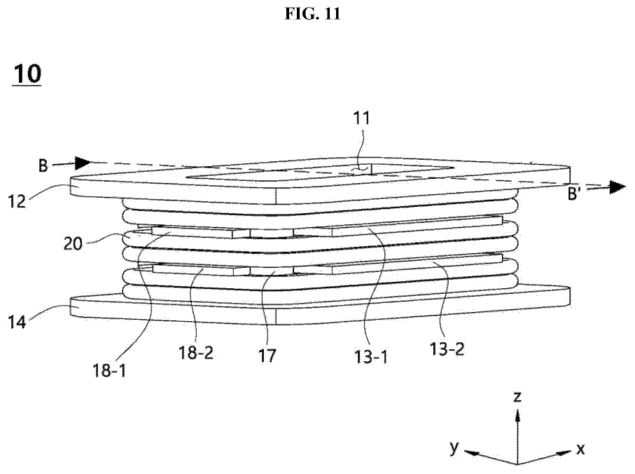

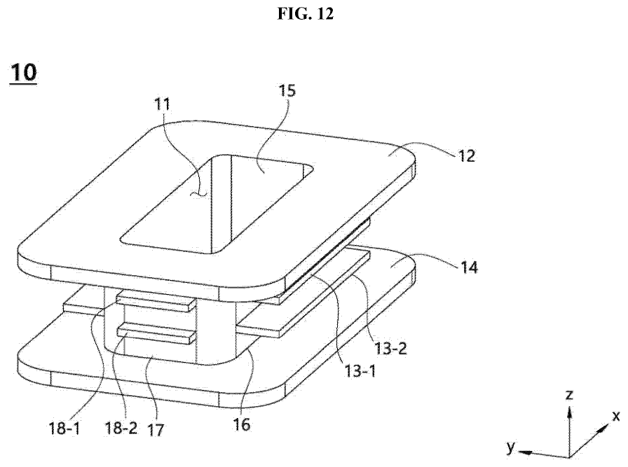

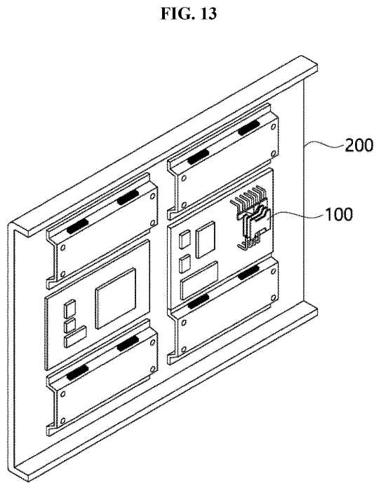

FIG. 11 is a perspective view of a transformer according to a fourth embodiment of the present disclosure, and FIG. 12 is a view of an embodiment of the bobbin in FIG. 11.

When a part has a large height and thus has an extra space and the number of windings of the coil to be wound is large, as in the second embodiment, another section may be added to the body part of the bobbin in order to more effectively separate the windings. This is merely exemplary, and more sections may be added in order to further divide the winding space.

Unlike the embodiment in FIG. 9, a bobbin 10 of a transformer in which two first sections 13-1 and 13-2 and two second sections 18-1 and 18-2 are formed is shown. Although the two first sections 13-1 and 13-2 and the two sections 18-1 and 18-2 are illustrated as dividing the winding space into three winding spaces S1, S2, and S3 having the same size, this is merely a preferred embodiment, and the winding spaces S1, S2, and S3 may be formed to have different sizes depending on the positions at which the sections are formed on the outer peripheral surface 16 of the body part 15.

In addition, although the two first sections 13-1 and 13-2 are illustrated as having the same thickness and the same width, this is merely a preferred embodiment, and the two sections may have different thicknesses or different widths as needed.

The transformers having various configurations described above may be mounted on a board 200, as shown in FIG. 13, and may be used in a power supply unit.

The transformer according to the present disclosure may divide the winding space using the section to separate the coil windings, thereby effectively reducing parasitic capacitance. In this way, because the parasitic capacitance is reduced, malfunction of the board may be prevented.

Further, the smaller the distance between the windings, the higher the risk of the wiring portion being short-circuited. However, according to the present disclosure, because the wirings are separated by the section, a contact area at the wiring portion may be reduced, and accordingly, insulation stability may be increased.

Furthermore, because the wirings are uniformly arranged in the wiring spaces divided by the section, inductance dispersion may be improved, and accordingly, an error rate may be reduced.

Although the exemplary embodiments of the present disclosure have been disclosed for illustrative purposes, those skilled in the art will appreciate that various modifications, additions and substitutions are possible, without departing from the scope and spirit of the disclosure as disclosed in the accompanying claims.

### INDUSTRIAL APPLICABILITY

The transformer according to the present disclosure may be used as a unit that supplies power in a flat panel display device.

1. A transformer, comprising:
a core unit including an upper core and a lower core;
a bobbin including a through-hole formed in a center thereof so as to accommodate at least a part of the core unit; and
a coil unit at least partially accommodated in the core unit, the coil unit being disposed on an outer peripheral surface of the through-hole, the coil unit including a primary coil and a secondary coil,
wherein the bobbin includes:
an upper flange protruding from an end of the outer peripheral surface of the through-hole in an outer diameter direction;
a lower flange protruding from an opposite end of the outer peripheral surface of the through-hole in the outer diameter direction; and
at least one section disposed between the upper flange and the lower flange, the at least one section protruding from the outer peripheral surface of the through-hole in the outer diameter direction.

2. The transformer according to claim 1, comprising:
an upper winding space defined between the upper flange and the section; and
a lower winding space defined between the lower flange and the section,
wherein the coil unit is disposed in the upper winding space and the lower winding space.

3. The transformer according to claim 2, wherein the primary coil and the secondary coil at least partially overlap each other in the outer diameter direction.

4. The transformer according to claim 3, wherein the section is provided in plural.

5. The transformer according to claim 3, wherein the upper flange and the lower flange have widths equal to or less than a width between inner peripheral surfaces of the through-hole closely facing each other.

6. The transformer according to claim 3, wherein the section has a thickness equal to or less than thicknesses of the upper flange and the lower flange.

7. The transformer according to claim 6, wherein the section has a thickness formed to be 0.4 to 0.7 times the thicknesses of the upper flange and the lower flange.

8. The transformer according to claim 3, wherein the section has a width formed to be 0.3 to 0.9 times widths of the upper flange and the lower flange.

9. The transformer according to claim 3, wherein the section has a width formed to be 0.4 to 0.7 times widths of the upper flange and the lower flange.

10. The transformer according to claim 8, wherein the coil has a winding width less than the width of the section.

11. A transformer, comprising:
a core unit including an upper core and a lower core;
a bobbin including a through-hole formed in a center thereof so as to accommodate at least a part of the core unit; and
a coil unit at least partially accommodated in the core unit, the coil unit being disposed on an outer peripheral surface of the through-hole, the coil unit including a primary coil and a secondary coil,
wherein the bobbin includes:
an upper flange protruding from an end of the outer peripheral surface of the through-hole in a first direction and a second direction perpendicular to the first direction;
a lower flange protruding from an opposite end of the outer peripheral surface of the through-hole in the first direction and the second direction;
a first section disposed between the upper flange and the lower flange, the first section protruding from the outer peripheral surface in the first direction; and
a second section protruding from the outer peripheral surface in the second direction on a same line as the first section by a width equal to or less than a width of the first section.

12. The transformer according to claim 11, wherein a ratio of the width of the second section protruding from the outer peripheral surface to the width of the first section protruding from the outer peripheral surface is 0.1:1 to 1:1

13. A power supply unit, comprising:
the transformer according to claim 1; and
a board configured to allow the transformer to be mounted thereon.

14. The transformer according to claim 11, comprising:
an upper winding space defined between the upper flange and each of the first and second sections; and
a lower winding space defined between the lower flange and each of the first and second sections,
wherein the coil unit is disposed in the upper winding space and the lower winding space.

15. The transformer according to claim 14, wherein the primary coil and the secondary coil at least partially overlap each other in the first and second directions.

16. The transformer according to claim 15, wherein the upper flange and the lower flange have widths equal to or less than a width between inner peripheral surfaces of the through-hole closely facing each other.

17. The transformer according to claim 15, wherein each of the first and second sections has a thickness equal to or less than thicknesses of the upper flange and the lower flange.

18. The transformer according to claim 17, wherein the first section has a thickness formed to be 0.4 to 0.7 times the thicknesses of the upper flange and the lower flange.

19. The transformer according to claim 15, wherein the first section has a width formed to be 0.3 to 0.9 times widths of the upper flange and the lower flange.

20. The transformer according to claim 15, wherein the first section has a width formed to be 0.4 to 0.7 times widths of the upper flange and the lower flange.
